(19) United States
(12) Patent Application Publication
(10) Pub. No.: US 2012/0266573 A1
(43) Pub. Date: Oct. 25, 2012

(54) EASY INSERTION/REINSERTION STOPPER FOR USE WITH STILL WINE

(76) Inventors: Miguel Freire de Albuquerque Ferreira Cabral, Porto (PT); Paulo Dinis Vale Lopes, Espinho (PT); Isabel Maria Ribeiro de Almeida de Lima Roseira, Porto (PT)

(21) Appl. No.: 13/516,637

(22) PCT Filed: Nov. 30, 2010
(86) PCT No.: PCT/PT10/00052

§ 371 Date: Jul. 10, 2012

(30) Foreign Application Priority Data
Dec. 17, 2009 (PT) 104894

(51) Int. Cl. B65D 39/00; B67B 1/04

(52) U.S. Cl. 53/489

(57) ABSTRACT

The present invention relates to the use of suitable sized cork stoppers for spirit wine with still wine. More particularly, relates to the use of “Bartop” stoppers with still wine bottles. The use of stoppers having a cork body which diameter size exceeds just about 0.5 to 3 mm the neck diameter of still wine bottles to be sealed, enables to keep the organoleptic attributes of wine while prevents wine leakage from bottles regardless its storing position.

### FIELD OF THE INVENTION

The present invention relates to the use of suitable sized cork stoppers for spirit wine with still wine. More particularly, relates to the use of “Bartop” stoppers with still wine bottles.

### BACKGROUND OF THE INVENTION

Cork stoppers are used since the 18^{th} Century for closing and/or sealing wine bottles and they are highly spread into the market. Generally, there were no alternatives for cork stoppers until plastic sealing stoppers have emerged in the middle of 90's of the 20^{th} Century.

The role of a stopper in a still wine bottle is to seal the bottle in order to prevent liquid leakage and, at the same time, to enable the harmonious development of wine inside the bottle.

The size of stoppers more frequently used in still wine bottles is 24 mm diameter and 38-54 mm length, for normalized bottlenecks. These dimensions assure, on the one hand, the sealing of the bottle and, on the other hand, the normal development of wine over time.

The difference between the diameter of a stopper and the inner diameter of a neck of a still wine bottle is usually 5-6 mm. This difference between diameters requires the mechanical insertion of a stopper into a neck by means of a compression force for total insertion into the neck. This type of stoppers ensures the sealing of bottles enabling its horizontal storage and preventing significant entrance of oxygen into the bottles which usually cause wine oxidation.

Usually the length of a stopper for use in still wine bottles varies from 38 to 54 mm. The option between higher or lower lengths of stoppers in this range does not depend on the development of wine but on commercial issues. High-end quality wines are usually sealed with stoppers of 54 mm length, while mid-end or low-end quality wines are sealed with stoppers of 38 mm length.

Stoppers for sparkling wines are within this well known group of stoppers. These stoppers also seal bottles and are additionally able to be manually removed. This manual removal is possible since there is an internal pressure from the gas of wine, which pressure helps said manual removal. However, in view of the characteristics of these wines, the required dimensions of stoppers are about 48 mm length and about 30.5 to 31 mm diameter, corresponding to a diameter difference between the stopper and the neck higher than 10 mm. The international application WO 2006/061858 discloses stoppers for sparkling wine bottles.

In another group of stoppers there are those used in spirit bottles (such as the well known “Bartop” stoppers which have a capsule made of a material other than cork) with lengths from 20 to 32 mm (the preferred length is 27 mm), of which length about 18-21 mm is inside the bottle.

The usual diameters of spirit stoppers vary from 13.5 to 24 mm, the diameters of 18 to 20 mm being more used. In this case, the difference between the inner diameter of a normalized bottleneck and the diameter of the stopper ranges from about 0.5 to 3 mm enabling stopper insertion only by impact instead of compression. The capsule stoppers are generally intended for closing but not sealing bottles of spirit drinks. In fact, these bottles are vertically stored in order to prevent liquid leakage, and the oxidation issues are not important since these drinks have high alcohol content which prevents said oxidation. Thus, the main purpose of these stoppers is closing and not sealing the bottles.

More recently, cork stoppers made of two members were developed, wherein one of members is a head for extraction of the stopper from the bottle without using a corkscrew, and the other member is a body. The body lies inside the bottle and has a similar length to that of corks for use in spirit wine bottles but having a diameter of about 23 to 24 mm, within the range of diameters from stoppers used in still wine bottles. Thus, the difference between these stoppers diameter and the neck inner diameter is about 5 to 6 mm, enabling sealing and preventing premature oxidation of wines. Due to its characteristics, these stoppers are used in still wine bottles while imparting the user the chance to reuse them by means of manual insertion/removal, thereby preventing the use of a corkscrew. These stoppers are disclosed in the International application WO 2009/145652.

Lastly, reference is made to sealing stoppers of plastic material. These stoppers are intended to imitate the cork stoppers both in relation to its general appearance, namely to dimensions and physical appearance, and with respect to sealing efficiency. Sometimes, like in the case of cork stoppers, a corkscrew for extraction of these plastic stoppers is needed. The main drawback of these plastic stoppers is the fact they can not assure similar level of sealing in comparison with cork stoppers.

Thus, for short-term bottle storage, the wine withstands the amount of oxygen that enters the bottle due to defective sealing. However, with longer storage periods, premature oxidation signs are noticed which significantly change organoleptic attributes of wine. The International application WO 2006/064137 discloses a stopper device for closing and sealing wine and spirit bottles, made of three members (one of cork and two of plastic material), intended to overcome bottling, uncorking and cork brittleness problems.

### SUMMARY OF THE INVENTION

The present invention relates to the use of stoppers, usually for spirit bottles, in still wine bottles. Such a stopper, for sealing a bottle containing still wine, comprises a cork body which has a diameter exceeding the inner diameter of a still wine bottleneck in about 0.5 to 3 mm.

In one aspect of the invention said stopper body has a diameter exceeding the inner diameter of said still wine bottleneck in about 0.5 to 2.5 mm.

In another aspect, said stopper body may be substantially cylindrical or cone-shaped.

Still in another aspect of the invention, the stopper to be used in a bottle containing still wine comprises a body with diameter of about 17.5 to 20.5 mm.

In another aspect of the invention, said stoppers with diameter of about 17.5 to 20.5 mm are intended to be used in necks of bottles containing still wine, which bottlenecks have inner diameters of about 16.5 to 18.5 mm.

The invention also relates to the use of a stopper, comprising a cork body, which body has a diameter of about 18 to 20 mm, in a bottle with inner diameter neck of about 17 to 18 mm, which stopper is intended to seal said bottle containing still wine.

Still in another aspect of the invention, said still wine bottles are intended to be vertically or horizontally stored after bottling.

### BRIEF DESCRIPTION OF THE DRAWINGS

FIG. 1 shows a graph regarding transmission of oxygen from different types of capsule stoppers over 12 months in bottle.

FIG. 2 shows a graph regarding free SO₂ concentration in white wine which was sealed with different stoppers over 12 months of horizontal and vertical storage.

FIG. 3 shows a graph regarding total SO₂ concentration in white wine which was sealed with different stoppers over 12 months of horizontal and vertical storage.

FIG. 4 shows the ranking of development from sensory analysis of white wine sealed with different stoppers after 3 months of horizontal (upper graph) and vertical (lower graph) storage of the bottles.

FIG. 5 shows the ranking by preference of white wine sealed with different stoppers after 3 months of horizontal (upper graph) and vertical (lower graph) storage of the bottles.

FIG. 6 shows the ranking of development (upper graph) and preference (lower graph) obtained from a sensory analysis of white wine sealed with different stoppers after 12 months of horizontal storage.

FIG. 7 shows the ranking by development (upper graph) and preference (lower graph) obtained from white wine sealed with different stoppers after 12 months of vertical storage of bottles.

### DETAILED DESCRIPTION OF THE INVENTION

In present specification, the term “cork material” or just “cork” relates to natural cork, colmated natural cork, agglomerated cork, micro-agglomerated cork or combinations thereof.

The term “agglomerated cork” relates, according to standard ISO 2190, to cork material comprising at least 5:1% (by weight) of granulated cork having minimum granulometry of 0.5 mm, highest density of 60 Kg/m³ and water content equal or less than 8%.

The term “micro-agglomerated cork” relates to agglomerated cork, wherein its cork grain granulometry is about 0.5 to 2 mm.

The term “natural cork stopper” or “natural stopper” relates to a stopper comprising one body having natural cork only.

The term “colmated natural cork stopper” or “colmated stopper” relates to natural cork stoppers having its pores filled with cork dust.

The term “agglomerated cork stopper” or “agglomerated stopper” relates to a stopper comprising one body of agglomerated cork with granulometry above 2 mm.

The term “micro-agglomerated cork stopper” or “micro-agglomerated stopper” relates to a stopper comprising one body of micro-agglomerated cork.

The term “manual” or “manually” relates to any action performed by a user without use of automated, mechanical, electrical or electronic devices or the like.

The term “neck diameter” relates to the inner diameter of a bottleneck, which inner diameter is measured at entry of said neck.

The term “normalized neck” relates to a neck having neck diameter ranging about 16.5 to 18.5 mm.

Terms “stopper head”, “stopper capsule” or simply, “head” or “capsule”, relate to the part of a stopper which lies outside the bottleneck after bottling. The head of a stopper enables user handling of the latter when he(she) attempts to remove or insert the stopper in the bottle. This part of the stopper may be made of any suitable material.

The term “stopper body” or simply “body”, relates to the stopper part which lies fully inside the bottleneck after bottling. This is the stopper part that closes and/or seals the bottle when the stopper is inserted. The shape of a stopper body is substantially cylindrical or conical and may be chamfered or rounded at the bottleneck insertion end or this end may receive at least one disk of natural cork if necessary.

The term “body diameter” or “diameter” (if in the wording it is clear that this term relates to the body of a stopper), relates to the larger dimension of a stopper body diameter, unless otherwise mentioned.

The term “sparkling” relates to wine having a certain amount of carbon dioxide for causing the durable formation of bubbles.

The term “spirit” relates to beverages containing alcohol amounts higher than about 14%, such as for example, liquor, brandy, whisky, port wine, Madeira wine, muscatel, etc.

The term “still wine” relates to white, red or Rosé wines that are not sparkling wines or spirit drinks.

The term “wine” relates to still wine unless otherwise mentioned.

The term “Bartop stopper” or “Bartop” relates to stoppers made of a natural cork, natural colmated, agglomerated or micro-agglomerated body and of a capsule of other material, such as for example wood or polypropylene. Typical diameters of these stoppers exceed about 0.5 to 3 mm the neck diameters of bottles.

The term “seal” or “sealing” relates to sealing of the stopper-bottle system in relation to liquids.

The term “chemical parameters” relates to the chemical analytic characteristics of a wine.

The term “organoleptic attributes” relates to characteristics of color, flavour and taste of wine.

The term “sensory characteristics” relates to organoleptic attributes.

The term “oxidation parameters” relates to variables from which the wine oxidation depends. Free and total SO₂ are oxidation parameters.

The term “free SO₂” relates to the wine amount of sulphur dioxide in free state.

The term “SO₂ total” relates to the wine amount of sulphur dioxide in free and combined state.

The present invention shows that contrarily to most of belief and practice of the prior art, a body stopper of cork material, which body diameter exceeds about 0.5 to 3 mm the inner diameter of a bottle normalized neck to be inserted, may be used in bottles containing still wine, while keeping the bottle sealed, the oxidation parameters or organoleptic attributes of wine according to the requirements of the art.

According to available literature and to stopper manufacture industrial processes, there always have been a difference between:
suitable stoppers for still wine, which body diameters should exceed about 5 to 6 mm the neck diameter (the normalized neck being the reference);
suitable stoppers for spirit drinks such as the well known “Bartop”, which body diameters should exceed about 0.5 to 3 mm the neck diameter of the bottle (the normalized neck being the reference) and
suitable stoppers for sparkling wines, which usually have diameters of about 30.5 to 31 mm, resulting in larger differences between the body diameter of stopper and the neck diameter than for preceding cases.

These differences were related with the conviction that the development of a still wine and the sealing of a bottle would be only ensured by stoppers with diameters exceeding about 5 to 6 mm the neck diameter where it should be inserted.

Surprisingly, such prior art requirements for sealing still wine bottles are not essential for a proper bottling, storage and harmonious development of a still wine. In fact, stoppers usually referenced as suitable for spirit wines are also suitable for use with still wine, keeping its requirements and with obvious ecologic advantages of cork material, saving and respective cost related advantages.

Other advantages of this new use are the stopper insertion in the bottle only by impact instead of compression; the merely manual removal of the stopper from the bottle which avoid the use of mechanical removal devices, and the following reuse of the stopper.

Unless otherwise mentioned, the values range shown herein is intended to provide a simplified and technically accepted way to denote each individual value within respective range. Each individual value of said range should be construed as it has been individually mentioned. By way of example, the term “1 to 2” means any value within this range, for example 1.0, 1.1, 1.2, 1.3, 1.4, 1.5, 1.6, 1.7, 1.8, 1.9, 2.0. All values mentioned in present specification should be construed as approximate values, for example, the reference to “2.0” means “about 2.0”.

In order to demonstrate said practicability of use of stoppers, which have been exclusively connected to spirit drinks, with bottles containing still wine, several tests were performed with stoppers substantially cylindrical, which description and results are shown herein below.

Firstly, it important to show the contribution of a cork stopper length for the development of wine. For that purpose micro-agglomerated stoppers and agglomerated stoppers with 24 mm diameter and 26, 32, 38 and 44 mm lengths were used. These stoppers were used to seal bottles containing white wine which were stored over 24 months. At several time points (4, 8, 12 and 24 months) analysis of oxidation parameters (free and total SO₂) were carried out, as well as to sensory characteristics of wines. Regarding the analyzed parameters, statistical relevant differences were not found between sealed wines with different length stoppers and in each time point. The results obtained enable to state that wine development does not depend on the stopper length.

Stoppers with body dimensions of 18 to 22 mm inserted length and 24 mm diameter were also compared with agglomerated stoppers of 38×24 mm. These stoppers were used for bottling white wine which was stored over 24 months. Wines were analyzed in relation to oxidation related parameters (free and total SO₂) as well as to sensory development, on a regular basis after 6, 12, 18 and 24 months of storage. The results obtained did not show any differences both in chemical and organoleptic parameters analyzed. Therefore, it was concluded that it is possible to use a stopper with less length and having a diameter similar to a traditional stopper in bottles containing still wine.

Several tests for assessing the importance of the stopper diameter on the development of still wine when sealed with stoppers normally used with spirit drinks are herein below described. As above mentioned, in addition to a smaller length these stoppers also have smaller diameter than those of stoppers normally used with still wine.

Tests and Results

1—Sealing Tests

Test 1.1

In this test micro-agglomerated stoppers were tested. These stoppers had capsule (or head). The test was carried out at room temperature.

The used stoppers had lengths of 20 and 25 mm and diameters of 17.5, 18.5, 19.5 and 20.5 mm, and they were lubricated by means of a standard surface treatment based on silicone elastomer.

The stoppers of this test were used for sealing 5 types of bottles with different neck profiles (Table 1). Bottles were filled with 12% ethanol solution stained with methylene blue. These bottles were horizontally stored at room temperature and monthly checked over a year for liquid leakage.

TABLE 1
Bottles with 5 different neck profiles

| | Micro-agglomerated stoppers** | | | | |
|---|---|---|---|---|---|
| | 20 × | | | | |
| Neck profile* | 17.5 | 20 × 18.5 | 20 × 19.5 | 20 × 20.5 | 25 × 18.5 |
| [mm] | [mm] | [mm] | [mm] | [mm] | [mm] |
| 18.4/18.6/19.4 | — | — | 3 | 2 | — |
| 16.4/17.7/18.8 | 2 | 3 | — | — | — |
| 17.5/18.2/18.9 | — | — | — | — | 5 |
| 17.2/17.9/18.7 | — | — | — | — | 5 |
| 17.8/19.5/19.9 | — | 2 | 3 | — | — |

*Mean neck profile of each of bottles at 0 mm, 20 mm and 30 mm depth.
**Length × diameter of stoppers is provided.

No leaks were visually (of bottle volume and/or drops on neck) or hand detected, by passing a hand over the bottleneck opening.

Test 1.2

In this test natural stoppers and agglomerated stoppers, with capsule, were tested. The test was carried out at room temperature.

The used stoppers had, respectively, 30, 20 and 25 mm length and 17.5, 18.5 e 19.5 mm diameter. Stoppers were lubricated by means of a standard surface treatment based on paraffin emulsion, silicone oil and silicone elastomer.

The stoppers of test were used for sealing 7 different neck profiles (Table 2). Bottles were filled with red wine e and horizontally stored at room temperature. They were monthly checked over one year for wine leakage.

TABLE 2
Bottles with 7 different neck profiles

| | Natural stoppers ** | | | Agglomerated stoppers ** | | |
|---|---|---|---|---|---|---|
| | 30 × | 30 × | 30 × | 20 × | 20 × | 25 × |
| Neck profile * | 17.5 | 18.5 | 19.5 | 19.5 | 18.5 | 18.5 |
| [mm] | [mm] | [mm] | [mm] | [mm] | [mm] | [mm] |
| 17.1/19.5/19.0 | — | 2 | — | — | 2 | — |
| 18.5/19.7/20.2 | — | — | 5 | 5 | — | — |
| 17.7/18.2/18.5 | — | — | 5 | — | — | 5 |
| 16.5/18.3/18.9 | — | — | — | — | 5 | — |
| 17.0/16.9/17.0 | 5 | — | — | — | — | — |
| 18.4/19.5/20.0 | — | — | 5 | — | — | — |
| 18.0/19.0/19.2 | — | — | — | — | — | 5 |

* Mean neck profile of each of bottles at 0 mm, 20 mm and 30 mm depth.
** Length × diameter of stoppers is provided.

No leaks were visually (of bottle volume and/or drops on neck) or hand detected, by passing a hand over the bottleneck opening.

Test 1.3

In this test micro-agglomerated stoppers and natural stoppers, with capsule, were tested. The test was carried out using variable temperatures.

Micro-agglomerated stoppers had 20 and 25 mm length and 18.5 mm diameter, the natural stoppers had 30 mm length and 18.5 and 20.5 diameter. Stoppers were lubricated by means of a standard surface treatment based on paraffin emulsion, silicone oil and silicone elastomer.

The stoppers of test were used for sealing bottles with different neck profiles (Table 3). Bottles were filled with 12% ethanol solution stained with methylene blue. These bottles were horizontally stored in alternate weekly cycles of temperature (40-45° C. and 20-22° C.) and monthly checked over 6 months for liquid leakage.

TABLE 3
Bottles with 4 different neck profiles

| | | | Micro-agglomerated | |
|---|---|---|---|---|
| | Natural stoppers** | | stoppers** | |
| Neck profile* | 30 × 18.5 | 30 × 20.5 | 20 × 18.5 | 25 × 18.5 |
| [mm] | [mm] | [mm] | [mm] | [mm] |
| 17.5/18.1/18.5 | — | — | 2 | — |
| 17.5/17.9/19.4 | — | — | — | 4 |
| 18.0/18.4/19.2 | — | 3 | — | — |
| 17.9/19.2/20.0 | 4 | — | 3 | — |

*Mean neck profile of each of bottles at 0 mm, 20 mm e 30 mm depth.
**Length × diameter of stoppers is provided.

After 6 months into bottle, no liquid leakage was noticed both visually and by hand.

### 2—Gas Sealing Test

Oxygen transmission which is allowed by different types of stoppers inserted into bottles was determined by a colorimetric method. This method is based on the calorimetric properties of a redox indicator (indigo carmine). Measurement of color parameters by spectrocolorimetry enables to measure the oxygen amount transferred through the stopper into the indigo carmine solution. This method was described in detail in 2005 (Lopes, P.; Soucier, C.; Glories, Y. (2005) Nondestructive Colorimetric method to determine the oxygen diffusion rate through closures used in winemaking. J. Agric. Food Chem. 53, 6967-6973) and applied to different types of cork stoppers, namely of natural cork, natural colmated, agglomerated, micro-agglomerated or combinations thereof.

Test 2.1

Micro-agglomerated and natural stoppers with capsule having, 25 mm length and 19.5 mm diameter were inserted into bottles having normalized neck (CETIE). The difference between the stoppers and the neck diameters' was 1 mm. These bottles had reduced indigo carmine, the entry of oxygen being assessed over time by spectrocolorimetry measurement. Bottles were horizontally and vertically stored.

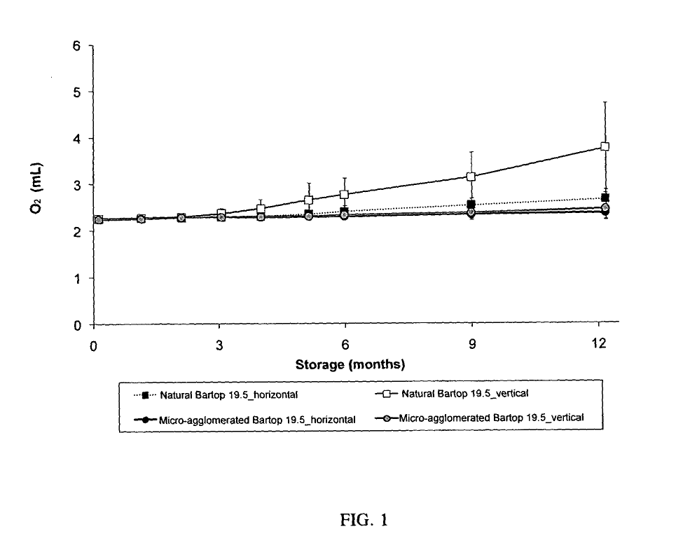

With reference to FIG. 1, after 12 months, results show that both bottles sealed with micro-agglomerated stoppers and those sealed with natural stoppers (these latter for horizontal storage) did not show oxygen entry into the bottles over time.

On the contrary, bottles sealed with natural stoppers but vertically stored show some oxygen entry. It should be further noted that the behavior of natural stoppers in vertically stored bottles is similar to the behavior of synthetic stoppers for this parameter.

Test 2.2

For the purpose of determining the still wine sealing ability of stoppers with capsule, a comparative test of white wine bottling was performed, in which:
natural stoppers with 38×24 mm (length×diameter), micro-agglomerated stoppers with 38×24 mm (length×diameter), synthetic stoppers with 39.7×21.9 mm (length×diameter), without capsule were used, and
micro-agglomerated stoppers with 25 and 30×19.5 mm and 25×20.5 mm (length×diameter) and natural stoppers with 25 and 30×19.5 mm and 25×20.5 mm (length×diameter) without capsule were used.

All stoppers were treated with standard lubricant products. Bottles used in this test had a neck diameter of 18.6 mm, 20.3 mm and 22.2 mm, respectively to 0 mm, 20 mm and 30 mm depth.

It should be noted that the difference between the diameter of stoppers without capsules and the neck diameter was about 1 to 2 mm.

All bottles sealed with natural stoppers, micro-agglomerated stoppers and synthetic stoppers, without capsule, were horizontally stored.

Half of bottles sealed with capsule stoppers were horizontally stored and, the remaining half were vertically stored.

In this test the room temperature and humidity were not controlled.

One day after bottling 3 bottles sealed with stoppers without capsule were analyzed just for checking wine quality. Parameters such as free and total SO₂, alcoholic strength by volume, density, pH, total and volatile acidity and reducing sugars were analyzed. Results obtained with these parameters confirm that, after bottling, wine had suitable quality.

After 3 and 6 and 12 storage months, tests of free and total SO₂ were performed in 5 bottles of each type of stopper and of each storage position; 3 bottles were organoleptically compared.

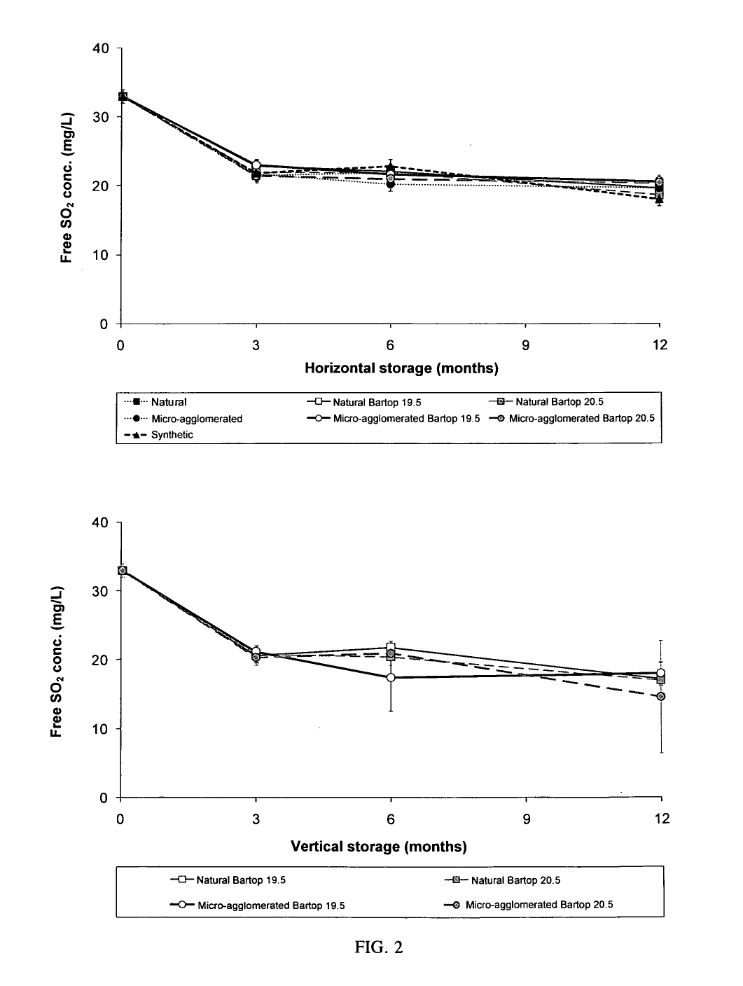

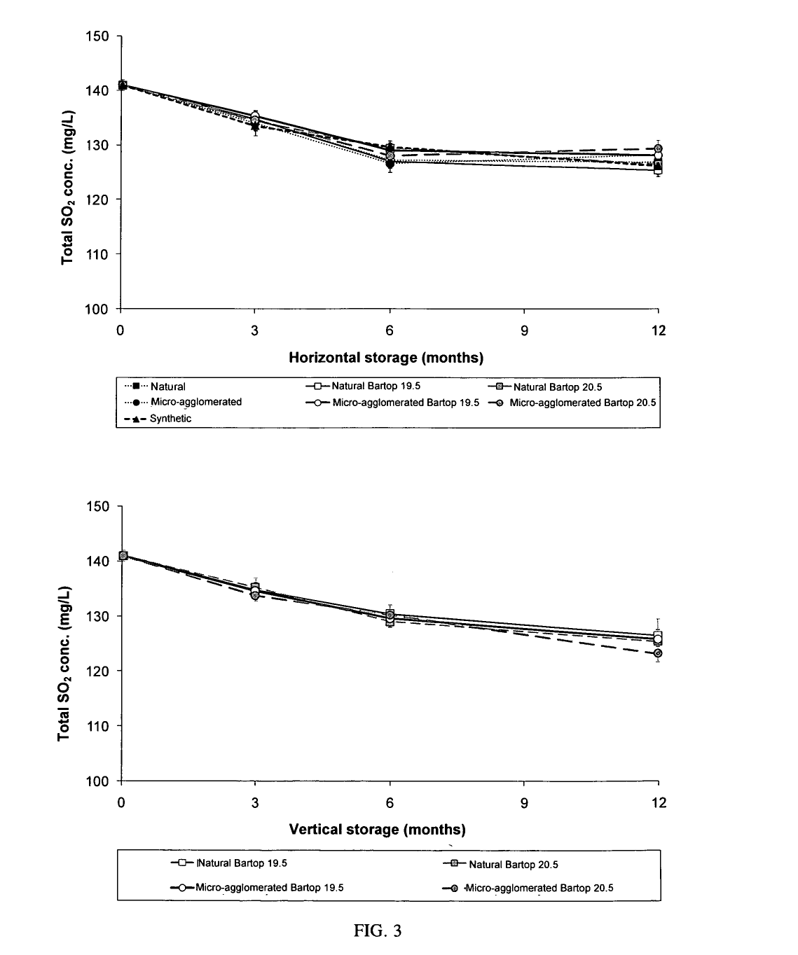

The results of free and total SO₂ for wine sealed with different stoppers and horizontally and vertically stored are shown in FIGS. 2 and 3, wherein FIGS. 2 and 3 show the concentration of, respectively, free SO₂ and total SO₂ in white wine over 12 months of horizontal and vertical storage. In figures, the bars show the standard deviation of 5 samples.

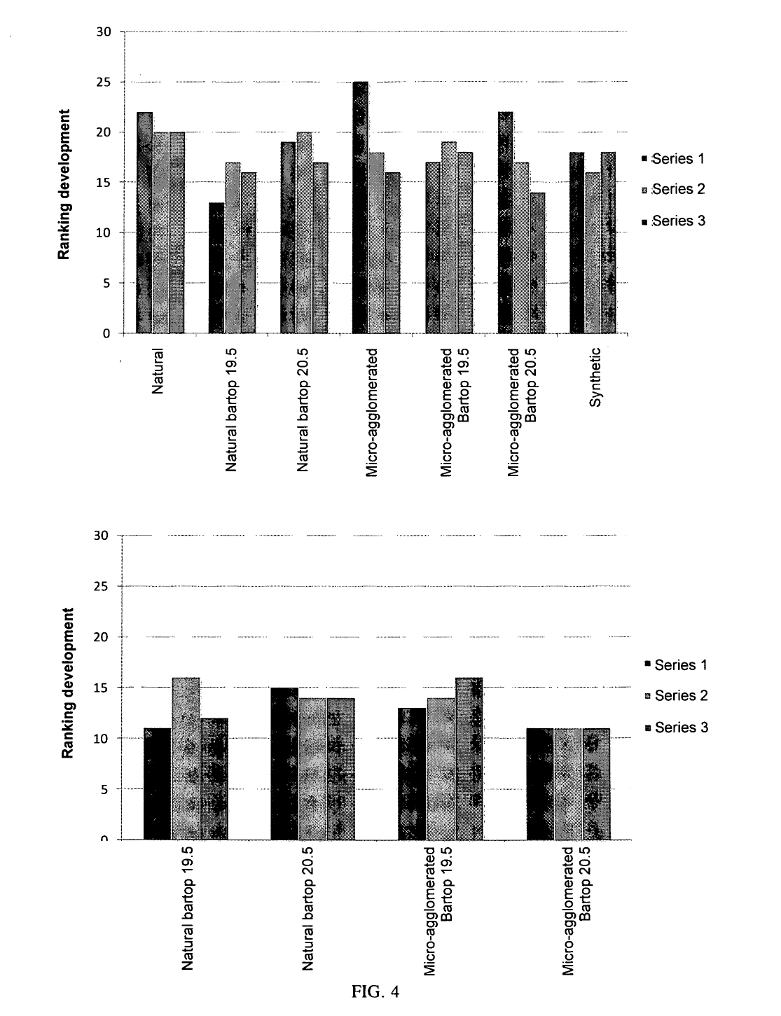

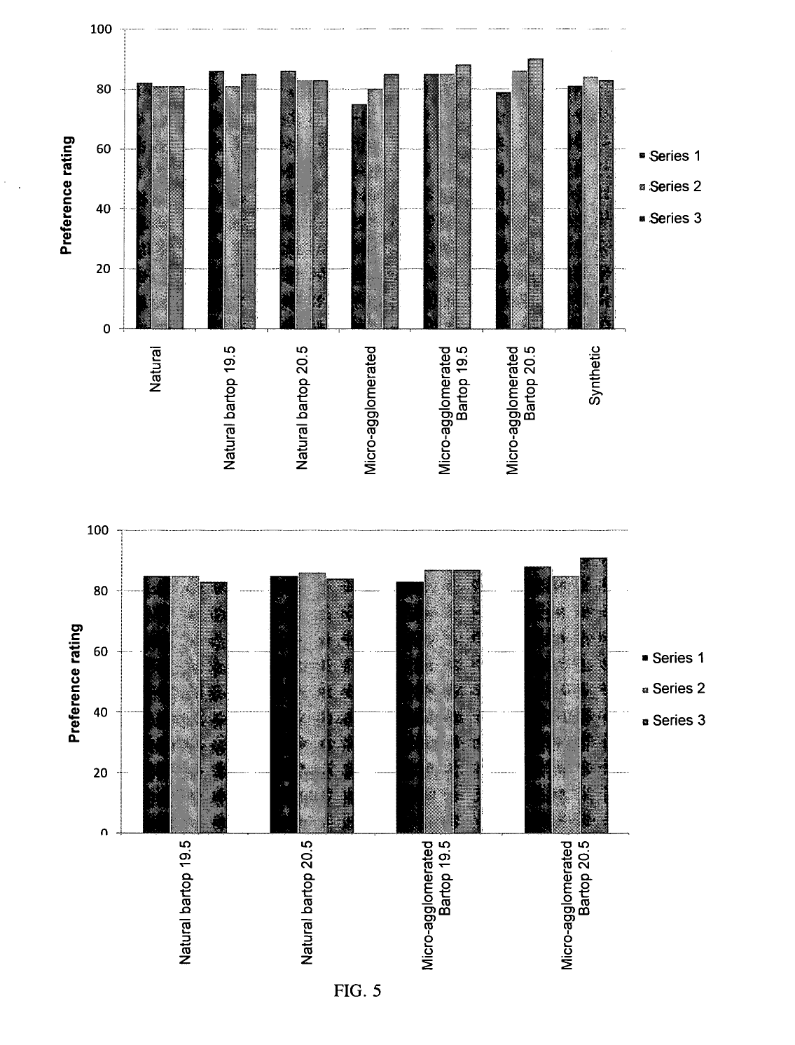

Further, tests of sensory analysis were performed for checking sensory development of wine. After 3 months, statistical analysis shows no significant differences regarding wine development (FIG. 4) and preference (FIG. 5), for all analyzed series of wine.

In relation to sensory developments of wine, sensory tests were made by 7 tasters. Lower value means less perception of sensory development, i.e., “younger”, see FIG. 4.

Regarding preference, sensory tests were also made by 7 tasters. Higher values means higher taster preference, see FIG. 5.

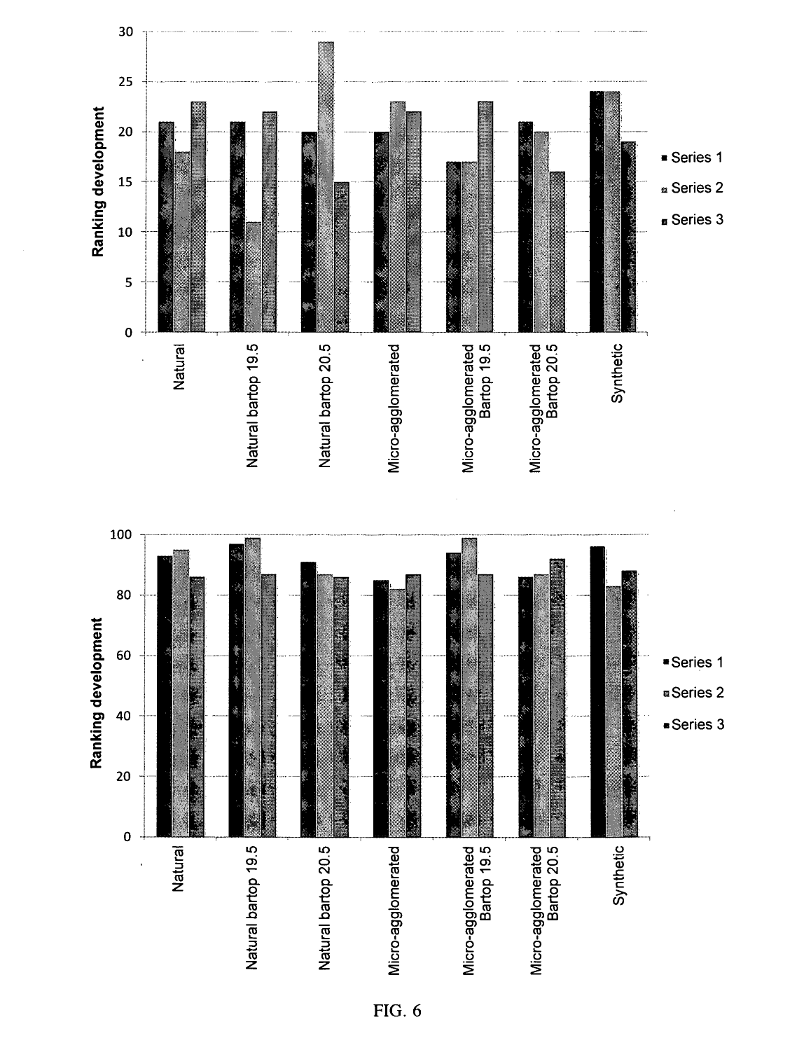

Statistic analysis shows that after 12 months, significant differences were not noticed in relation to development and preference for all series of horizontally stored wine, see FIG. 6.

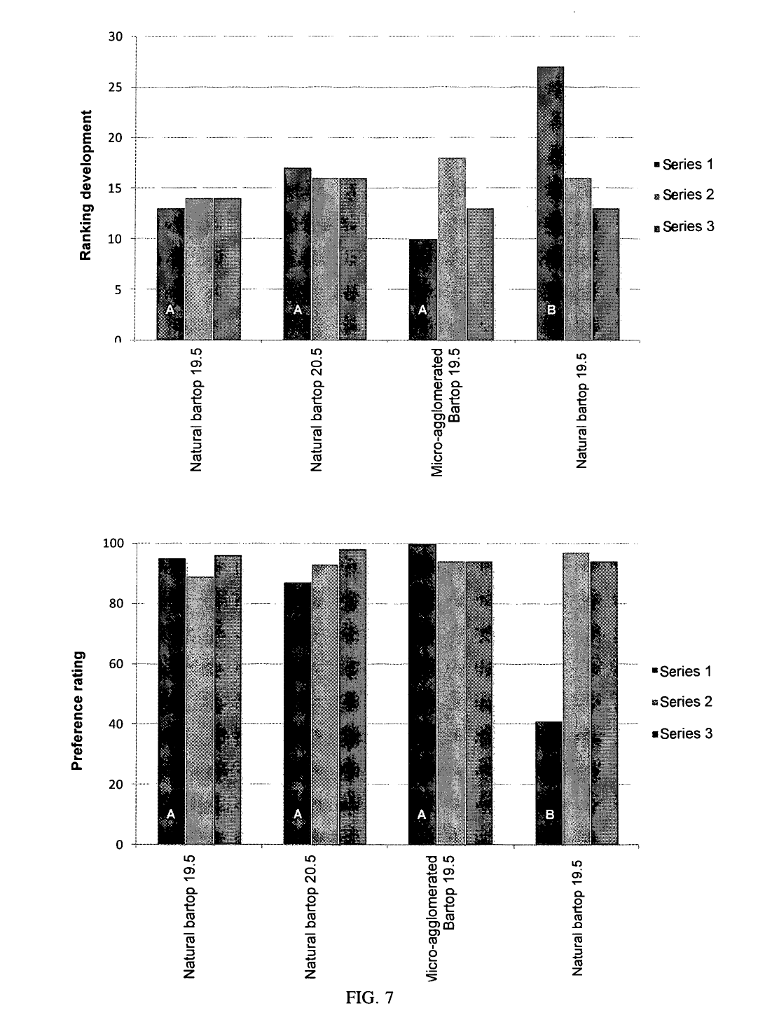

For vertically stored wine series, statistic analysis has shown significant differences of development and preference in one of 3 series of wine. In series 1, wine sealed with micro-agglomerated stoppers, with capsule, 19.5 mm body diameter, was considered as significantly more developed/oxidized and therefore less preferred than the remaining ones, see FIG. 7. This result is consistent with results from a chemical test, wherein the free SO₂ concentration in this bottle was 9 mg/L.

Each assessment and preference session had 6 tasters. A low value in graphs of FIG. 6 denotes a perception of less sensory development (i.e, “younger”).

Each taste session for vertically stored wine had also 6 tasters. A higher value in graphs of FIG. 7 denotes higher preference of tasters. Different letters in the same series denote statistical different samples.

The above results enable to safely conclude that, contrarily to stated in the prior art, the “Bartop” type stoppers may be used in bottles containing still wine, having the necessary sealing conditions which were believed to be only possible with stoppers of significantly higher diameter.

1. Use of a stopper comprising a cork body, which cork body has a diameter exceeding the inner diameter of a bottleneck in about 0.5 to 3 mm for sealing the bottle containing still wine.

2. The use of a stopper according to claim 1, wherein the diameter of said cork body exceeds the inner diameter of said bottleneck in about 0.5 to 2.5 mm.

3. The use of a stopper according to claim 1, wherein said cork body is substantially cylindrical.

4. The use of a stopper according to claim 1, wherein said cork body is cone-shaped.

5. The use of a stopper according to claim 1, wherein said cork body has a diameter of about 17.5 to 20.5 mm.

6. The use of a stopper according to claim 1, wherein said bottleneck has a inner diameter of about 16.5 to 18.5 mm.

7. The use of a stopper according to claim 1, wherein said cork body has a diameter of about 18 to 20 mm and said bottleneck has a inner diameter of about 17 to 18 mm.

8. The use of a stopper according to claim 1, wherein, after bottling, said still wine bottles are either vertically or horizontally stored.

9. The use of a stopper according to claim 1, wherein, after bottling, said still wine bottles are horizontally stored.
